(19) United States
(12) Patent Application Publication
(10) Pub. No.: US 2016/0302096 A1
(43) Pub. Date: Oct. 13, 2016

(54) Access Point and Extender Link Analysis, Data Stream Analysis, and Recommendations

(71) Applicants: Amalavoyal Chari, Redwood City, CA (US); Devabhaktuni Srikrishna, San Francisco, CA (US)

(72) Inventors: Amalavoyal Chari, Redwood City, CA (US); Devabhaktuni Srikrishna, San Francisco, CA (US)

(21) Appl. No.: 15/185,134

(22) Filed: Jun. 17, 2016

Related U.S. Application Data
(63) Continuation-in-part of application No. 14/736,615, filed on Jun. 11, 2015.
(60) Provisional application No. 62/144,867, filed on Apr. 8, 2015.
(60) Provisional application No. 62/144,876, filed on Apr. 8, 2015.

(51) Int. Cl. H04W 24/08; H04W 40/12

(52) U.S. Cl. CPC H04W 24/08; H04W 40/12

(57) ABSTRACT

Systems, methods and apparatuses for monitoring and controlling a connection quality of a wireless extender are disclosed. One apparatus includes a wireless extender, wherein the wireless extender includes a wireless transceiver and a controller. The wireless transceiver is operative to support a wireless connection between the wireless extender and an access point. The controller is operative to monitor a connection quality of the wireless link between the wireless extender and the access point, detect when the connection quality is less than a threshold, and select one or more recommendations when the connection quality is detected to be less than the threshold based upon a determined feasibility of each of a plurality of possible recommendations, wherein the plurality of possible recommendations includes moving the wireless extender, moving the access point, and adding a node between the wireless extender and the access point.

### RELATED APPLICATIONS

This patent application is a continuation-in-part (CIP) of U.S. patent application Ser. No. 14/736,615, filed Jun. 11, 2015, which claims the benefit of Provisional Patent Application Ser. No. 62/144,867, filed Apr. 08, 2015, and claims the benefit of Provisional Patent Application Ser. No. 62/144,876, filed Apr. 08, 2015, which are incorporated by reference.

### FIELD OF THE DESCRIBED EMBODIMENTS

The described embodiments relate generally to communication networks. More particularly, the described embodiments relate to analyzing performance metrics for a wireless network and providing recommendations for troubleshooting network problems and optimizing network performance.

### BACKGROUND

Wireless networks are becoming more prevalent in the home. Wireless networks comprise multiple different kinds of devices including client devices (such as wireless video cameras, wireless TV set-top boxes, wireless thermostats and smoke sensors) and wireless access devices including WiFi access points, extenders and mesh nodes.

Wireless communications between wireless devices can be implemented using a variety of technologies, including WiFi, Zigbee, Z-Wave, Bluetooth and cellular data (e.g., LTE). Wireless access devices include wireless access points, wireless extenders, wireless repeaters and wireless mesh nodes and gateways. Wired access devices include broadband modems such as cable or DSL modems. Backhaul connections can include technologies such as cable, DSL, metro Ethernet, fiber, satellite, and fixed wireless broadband.

Unlike wireless networks in the enterprise or other environments, home networks typically do not have an IT administrator that is expert in wireless or networking technologies. As such the traditional wireless network methodologies and tools such as RF planning, link engineering, configuration utilities, network management systems in the cloud or data center, application dashboards, etc are not usable by home network users. However the home user is increasingly reliant high-performance wireless network to support their applications, including video streaming, tele-conferencing using Skype® or Facetime®, web browsing, home video monitoring, etc. It is desirable to have a means to inform the lay-user of the performance of their home wireless network, to help them identify and troubleshoot network problems that affect their wireless performance, and to provide them simple recommendations to optimize and improve the network performance. It is desirable to have a simple and intuitive user interface to allow home users to monitor, troubleshoot, and optimize home wireless network performance.

The performance characteristics of wireless networks depend on a variety of factors including the number and location of wireless access devices, the locations of the client devices, the composition of building materials in the home, wireless signal fading characteristics, the noise and interference level on the wireless communications channels and links, the wireless frequency spectrum and the wireless access technologies, the link budgets and signal-to-noise ratios for the wireless links, etc. Wireless network performance is also variable in time, since these effects can change over multiple time scales including seconds, minutes, days, weeks or months. It is desirable to measure, characterize and report multiple wireless network performance metrics and to provide an assessment and recommendations to the home user to improve network performance.

It is desirable to have methods, systems and apparatuses for analyzing performance metrics for a wireless network and providing recommendations for troubleshooting network problems and optimizing network performance.

### SUMMARY

An embodiment includes a wireless extender. The wireless extender includes a wireless transceiver and a controller. The wireless transceiver is operative to support a wireless connection between the wireless extender and an access point. The controller is operative monitor a connection quality of the wireless connection between the wireless extender and the access point, determine when the connection quality fails a connection quality test comprising detecting instances when the connection quality drops below a performance threshold, wherein the performance threshold is adaptively set based on a data stream being forwarded by the wireless extender for one or more applications of one or more devices, and select one or more recommendations when the connection quality is determined to have failed the connection quality test, wherein the selected one or more recommendations includes changing a physical configuration of the network.

An embodiment includes a method. The method includes monitoring a connection quality of a wireless connection between a wireless extender and an access point of a network, determining when the connection quality fails a connection quality test comprising detecting instances when the connection quality drops below a performance threshold, wherein the performance threshold is adaptively set based on a data stream being forwarded by the wireless extender for one or more applications of one or more devices, and selecting one or more recommendations when the connection quality is determined to have failed the connection quality test, wherein the selected one or more recommendations includes changing a physical configuration of the network.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a wireless network that includes an access point and an extender, according to an embodiment.

FIG. 2 shows a wireless mesh network that includes an access point and an extender, according to an embodiment.

FIG. 3 shows a measurement of the quality of a communications path through a wireless mesh network, according to an embodiment.

FIG. 4 shows a measurement of the quality of a reverse communications path through a wireless mesh network, according to an embodiment.

FIG. 5 is a flow chart that includes steps of a method of monitoring and maintaining a connection quality between an extender and an access point, according to an embodiment.

FIG. 6 is a flow chart that includes steps of a method of determining wireless network recommendations to improve connection quality in a network that includes an extender and a wireless mesh network, according to an embodiment.

FIG. 7 shows a block diagram of an extender, according to an embodiment.

FIG. 8 shows a wireless network that includes an access point and an extender, wherein a recommendation to move the extender is selected to improve a connection quality between the extender and the access point, according to an embodiment.

FIG. 9 shows a wireless mesh network that includes access points and an extender, wherein a recommendation to move the extender is selected to improve a connection quality between the extender and one of the access points, or a link quality between the extender and an upstream device of the wireless mesh network, according to an embodiment.

FIG. 10 shows a wireless network that includes an access point and an extender, wherein a recommendation to move the access point is selected to improve a link quality between the extender and the access point, according to an embodiment.

FIG. 11 shows a wireless mesh network that includes access points and an extender, wherein a recommendation to move one or more of the access points is selected to improve a link quality between the extender and one of the access points, or a connection quality between the extender and an upstream device of the wireless mesh network, according to an embodiment.

FIG. 12 shows a wireless network that includes an access point and an extender, wherein a recommendation to add another access point is selected to improve a link quality between the extender and the access point, or a connection quality between the extender and an upstream device of a wireless mesh network, according to an embodiment.

FIG. 13 shows a wireless network that includes an access point and an extender, wherein a recommendation to add another access point is selected to improve a connection quality between the extender and the access point, or a connection quality between the extender and an upstream device of a wireless mesh network, according to an embodiment.

FIG. 14 is a flow chart that includes steps of a method of access point and extender link analysis, data stream analysis, and recommendations.

FIG. 15 is a flow chart that includes steps of a method of identifying and classifying a data stream, computing a minimum performance required by the data stream, setting a performance threshold based on the minimum performance, and detecting instances where the connection quality falls below the performance threshold, according to an embodiment.

### DETAILED DESCRIPTION

The embodiments described provide systems, methods and apparatuses for monitoring and maintaining a connection quality between a wireless extender and an access point, according to an embodiment. For an embodiment, the connection quality includes a link quality between the wireless extender and the access point. For an embodiment, the connection quality includes a path quality between the wireless extender and an upstream node of a wireless mesh network. An embodiment includes detecting a plurality of events and determining when the connection quality fails a connection quality test based on the detected plurality of events. An embodiment includes selecting one or more recommendations when the connection quality is determined to have failed the connection quality test, wherein the selected one or more recommendations includes changing a physical configuration of the network. An embodiment includes monitoring a connection quality of the wireless link between the wireless extender and the access point, detecting when the connection quality is less than a threshold, and select one or more recommendations when the connection quality is detected to be less than the threshold. For an embodiment, the recommendations include one or more of moving the wireless extender, moving the access point, or adding a node. For a wireless mesh network, for an embodiment, the recommendations include one or more of moving the wireless extender, moving one or more upstream access points, or adding an upstream access point to the wireless mesh network.

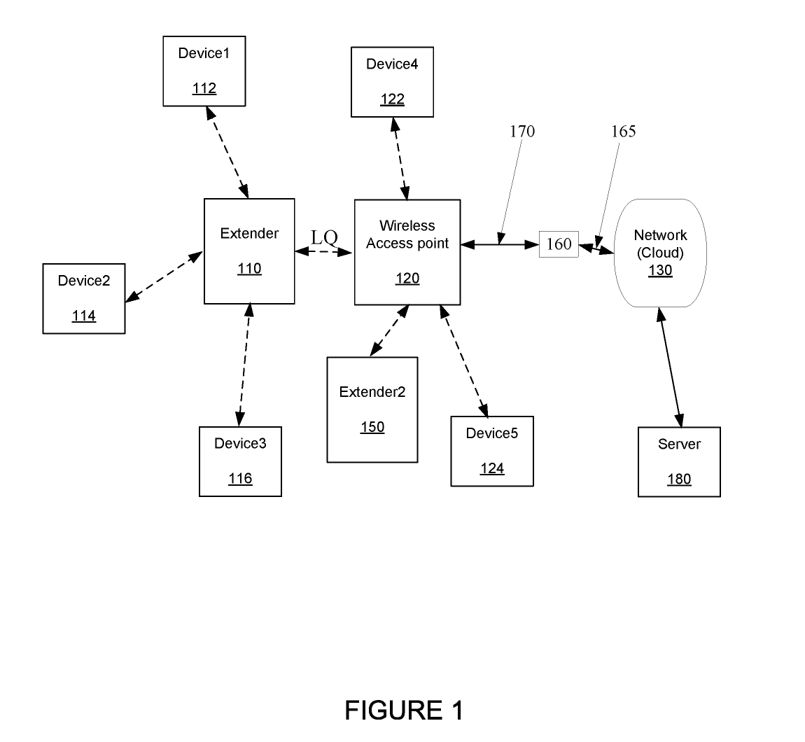

FIG. 1 shows a wireless network that includes an access point 120 and an extender 110, according to an embodiment. As shown, a link is formed between the access point 120 and the extender 110 that has a link quality (LQ). As described, the LQ is monitored. If the LQ falls below a threshold, at least some embodiments include providing recommendations for improving the LQ.

As shown, the extender 110 is connectable (able to maintain a communications channel) to a network 130 through access provided by the access point 120. Further, devices 112, 114, 116 are connectable to the network 130 through the extender 110 and the access point 120. Additionally, other extenders (such as, extender 150) and other devices 122, 124 can be connected to the access point 120.

The access point 120 is connected to a backhaul connection 165 through, for example, an Ethernet cable 170 connected, for example, to a cable modem 160. Generally, the backhaul connection 165 includes a broadband or narrowband Internet connection that can be provided through a variety of technologies including cable, DSL, dial-up, satellite, fiber, Ethernet, fixed wireless, Broadband Over Powerline (BPL), etc. Wireless client devices 112, 114, 116, 122, 124 such as a smartphone, laptop, and/or a wireless IP camera are wirelessly connected to the extender 110 or the access point 120 through wireless links. In addition, for at least some embodiments, there are Internet services such as DNS (Domain Name Service) and DHCP (Dynamic Host Configuration Protocol) that are provided by servers 180 on the Internet 130, such as a DNS server and/or by access devices such as the cable modem 160 functioning as a DHCP server.

For the client devices to be connected to the Internet, the Ethernet connection 170 should be up and active, the cable modern 160 needs to be powered up and activated, the backhaul connection 165 (usually provided by an Internet service provider) needs to be up and active, the DHCP server on the cable modem 160 needs to be active and dynamically allocating IP addresses to client devices 112, 114, 116, 122, 124 and DNS server 180 needs to be reachable and needs to be providing domain name resolution services. If one or more of these conditions are not met, the client device users 112, 114, 116, 122, 124 will be unable to connect to the Internet.

Loss of Internet connectivity is a common problem and can occur due to failures of any of the above connections or services. When Internet connectivity is lost, it is usually experienced by end users as web pages failing to load, or Netflix streams being interrupted, or VoIP calls getting dropped. Devices 112, 114, 116, 122, 124 such as a wireless IP camera or other connected devices such as thermostats, washing machines, sensors, etc. can experience connectivity failures as well, and in such cases it is hard for the network owner to even detect that connectivity has failed, since these devices don't have a display or other means of indicating that they have lost Internet connectivity.

Existing access devices, such as cable modems and wireless access points, fail to provide clear and comprehensible explanations of the cause of the connectivity failures, or what the user could do to fix the connectivity problem. As a result, users are forced to try to debug and identify the source of the problem on their own, usually by trying a variety of different steps such as power cycling the cable modem, disconnecting and reconnecting the Ethernet port on the wireless access point, etc. They may also call their service provider and ask them for help in resolving the problem.

It is desirable for the access device, such as a wireless access point 120 or extender 110, to be able to perform a sequence of tests to identify the source of the connectivity failure and to report that directly to the user in a simple and intuitive format along with clear actionable recommendations to fix the problem.

For at least some embodiments, the extender 110 connects wirelessly to the access point 120 through a wireless link (having link quality L(l), but can also serves as an access point for wireless client devices 112, 114, 116, such as smartphone client device. For an embodiment, each of these wireless devices is equipped with a WiFi radio. While WiFi is included here as an example of a commonly-employed wireless technology, but the described embodiments can utilize other wireless technologies such as Bluetooth, Zigbee, etc. For at least some embodiments, the wireless access point 120 and extender 110 are equipped, respectively, with attached displays. Further, for at least some embodiments, the devices 112, 114, 116 (such as, a smartphone client device) are equipped with a display.

Wireless technology, such as WiFi, has limited signal propagation range and the coverage area of an access point is limited. The speeds achievable over WiFi links decrease as the distance from the access point increases. As a result, it is often infeasible to cover an entire home with just a single AP. This is true for larger homes where the coverage provided by a single AP is insufficient. Furthermore, wireless signal strength decreases rapidly, often with the 3rd or 4th power of distance and this effect is exacerbated by obstructions such as walls or ceilings. Depending on the building construction materials, the signal may get cut down by 20 dB or more (a factor of 100) every time it goes through a wall. Some materials, such as brick and concrete, reduce signal more whereas other materials, such as drywall or plywood, have less of an effect on the signal. The effect of walls and ceilings is to reduce the coverage area, and this makes it even harder to cover an entire home with a single AP.

For at least some embodiments, the purpose of an extender 110 in a wireless network is to extend the signal of a wireless AP 120 that is wired into the home broadband connection. The extender 110 connects wirelessly back to the wireless AP 120, and then acts as an AP itself, so that client devices can connect directly to the extender 110 rather than to an AP (such as, AP 120) that is further away. In this way, an extender augments and extends the wireless coverage inside the home. People install extenders in the home in areas where they notice that coverage is poor.

There are two key requirements for an extender to be able to perform its function. The extender needs to be close enough to the AP so that it has a strong connection quality back to the AP. The extender also needs to be within an area of the home where the coverage is poor. For the descriptions of the disclosed embodiments, the connection quality refers to either a link quality between an extender and an upstream access node, or the path quality between the extender and an upstream node of a wireless mesh network location more than one wireless link from the extender.

Since an extender 110 connects back to the AP 120 wirelessly, the extender 110 only needs to be plugged into a power outlet. As such, there are often multiple choices of location to place the extender. There are often multiple power outlets even within a single room where coverage is desired. Not all of these locations are equally optimal from the perspective of coverage and connectivity. Because wireless signal propagation is variable and unpredictable, it is often not obvious to the user what the best place is to plug the extender in. It is also hard to predict, before the fact, whether or not a particular location is a good place to plug in the extender. Plugging it in in a poor location can result in weak connectivity back to the AP 120, and so client devices that connect to the extender 110 will experience low throughputs and poor performance. Furthermore, wireless propagation changes over time due to changes in the environment and other factors such as noise and interference. As such, an extender which performs well at a particular location at a certain time may no longer work well at that location a few weeks later, and the best solution may be to find a better place to move the extender to.

As previously described, for at least some embodiments, the extender 110 measures the connection quality (link quality (LQ) of FIG. 1) to the AP 120. There are many possible ways of assessing the connection quality between the extender 110 and the AP 120. As previously described, for the descriptions of the disclosed embodiments, the connection quality refers to either a link quality between an extender and an upstream access node, or the path quality between the extender and an upstream node of a wireless mesh network location more than one wireless link from the extender. In one embodiment, the extender measures the Signal to Noise Ratio (SNR) of frames received from the AP. In one embodiment, these frames are data frames. In one embodiment, these frames are routing packets. In one embodiment, these frames are 802.11 Beacon frames. In one embodiment, the extender measures the Received Signal Strength Indicator (RSSI) of frames received from the AP. In one embodiment, the extender measures a Link Packet Error Rate (LinkPER) or Link Packet Success Probability (LinkPSP) of the link to the AP by sending packets, such as ping packets, to the AP and comparing the number of responses received to the number of packets sent. In one embodiment, the extender measures a LinkPSP based on the number of routing packets or 802.11 Beacons received from the AP in a given time, compared to the number of such routing packets or 802.11 Beacons known to have been transmitted by the AP in that time period. For example, if it is known that the AP transmits 100 packets of a given type in every second, and the extender (on average) only receives 60 such packets per second, then the extender 110 measures a LinkPSP of 60/100=0.6, which is a measure of the quality of the link from the AP 120 to the extender 110. For an embodiment, the extender transmits packets to the AP 120 allowing the AP 120 to measure the PSP for the link from the extender to the AP 120. The AP 120 can then report this measurement to the extender. In this way, the extender 110 has a measurement of the ReverseLinkPSP for the link from the extender to the AP 120. For an embodiment, the extender measures the modulation rates used on packets sent by the AP 120 as well as the modulation rates for packets sent by the extender 110. For an embodiment, the extender 110 estimates the throughput on the link from the AP 120 to the extender 110 based on the packet error rate and the modulation rate used on the link. In one embodiment, the extender 110 estimates the Uplink Expected Transmission Time (UL-ETT) on the link from the extender 110 to the AP 120 based on the ReverseLinkPSP and the modulation rate used by the extender 110. For an embodiment, the extender 110 estimates the Downlink Expected Transmission Time (DL-ETT) on the link from the AP 120 to the extender 110 based on the LinkPSP and the modulation rate used in packets transmitted by the AP 120. For an embodiment, the extender 110 estimates a Round-Trip ETT (RT-ETT) by summing the Expected Transmission Times for the Uplink and the Downlink: RT-ETT=DL-ETT+UL-ETT. For an embodiment, the extender 110 measures the throughput on the link between the extender 110 and the AP 120 by performing a throughput test (such as Iperf or nuttcp) to the extender 110. For an embodiment, the extender 110 measures the latency of the link to the AP 120 by measuring and averaging the round-trip time for ping packets sent to the AP 120 and ping responses received from the AP 120.

The link quality between the extender 110 and the AP 120 can vary over time due to changes in the physical environment, variations in noise and interference levels, and other factors. As such, it is desirable to know not just the instantaneous value of the link quality, but also how reliable or stable that connection quality is and to quantify the connection reliability as measured by frequency of dropouts or reductions in quality of service or throughput. As previously described, for the descriptions of the disclosed embodiments, the connection quality refers to either a link quality between an extender and an upstream access node, or the path quality between the extender and an upstream node of a wireless mesh network location more than one wireless link from the extender.

For an embodiment, the extender 110 measures an instantaneous (real-time) connection quality to the AP 120. For an embodiment, the extender 110 measures a connection quality to the AP 120 over a period of time, T. For an embodiment, the period of time T could be much larger than a second—for example T could be several minutes, hours or days. For an embodiment, the extender 110 measures an average of the connection quality over a period of time, T. For an embodiment, the extender 110 compares the measured average connection quality to a performance threshold to determine if the connection quality exceeds or falls below the performance threshold. For an embodiment, the extender measures a number of times (N) within the time period T, that the connection quality drops below the performance threshold. For an embodiment, the extender 110 measures a fraction (f) of the overall time T that the connection quality falls below the threshold. For an embodiment, the extender measures an average duration (D) of events where the connection quality drops down below the performance threshold. For an embodiment, the extender 110 measures a value that the connection quality exceeds at least X percent of the time, where X is a predetermined percentage. For example, if X=95%, the extender 110 measures the value that the connection quality exceeds 95% of the time. As previously described, for the descriptions of the disclosed embodiments, the connection quality refers to either a link quality between an extender and an upstream access node, or the path quality between the extender and an upstream node of a wireless mesh network location more than one wireless link from the extender.

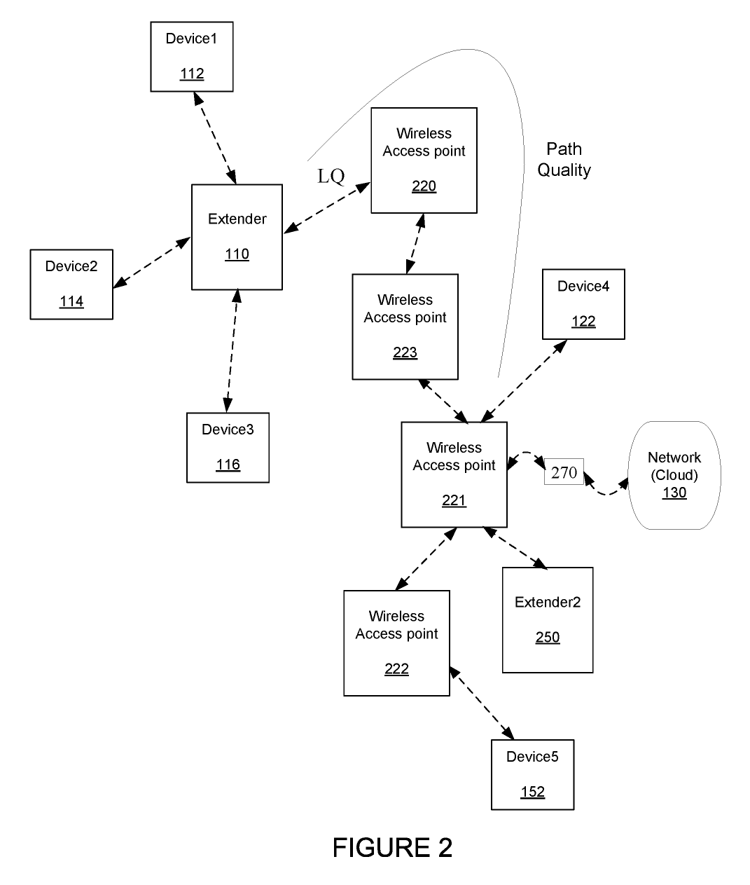

For an embodiment, the extender detects a plurality of events. For an embodiment, the plurality of events includes instantaneous measurements of the connection quality. For an embodiment, the connection quality includes the link quality LQ as shown in FIG. 1. For an embodiment, the connection quality includes the path quality of a connection path through a wireless mesh network as shown in FIG. 2). For an embodiment, the plurality of events includes instances where a connection quality drops below a performance threshold. For an embodiment, the plurality of events includes instances where the connection quality exceeds a performance threshold.

For an embodiment, the extender determines when the connection quality fails a connection quality test based on the plurality of detected events. For an embodiment, the plurality of detected events includes instances where the connection quality drops below a performance threshold, and the connection quality test is deemed to have failed if the number of detected events within a specified duration exceeds an allowable maximum number. For an embodiment, the plurality of events includes detecting instantaneous measurements of the connection quality, and the connection quality test is deemed to have failed if the average of the instantaneous connection quality measurements over a specified duration falls below a minimum threshold value. For an embodiment, the plurality of events includes detecting a sequence of instantaneous measurements of the connection quality within a specified time interval, and the connection quality test is deemed to have failed if the number of instantaneous connection quality measurements within that time interval that fall below a threshold value (t) exceed a threshold fraction (f) of the overall number of instantaneous measurements within that time interval. For an embodiment, the plurality of events includes a detecting sequence of instantaneous measurements of the connection quality within a specified time interval, and the connection quality test is deemed to have failed if the number of consecutive connection quality measurements within that time interval that fall below a threshold value (t), exceed a threshold number.

For at least some embodiments, the extender 110 includes a controller. For at least some embodiments, the controller is operative to monitor a link quality of the wireless link between the wireless extender and the access point, detect when the link quality fails a link quality test, and select one or more recommendations when the link quality is detected to have failed a link quality test, wherein the plurality of possible recommendations includes changing a physical configuration of the network. For an embodiment, changing a physical configuration of the network includes moving the wireless extender. For an embodiment, changing a physical configuration of the network includes moving the access point. For an embodiment, changing a physical configuration of the network includes adding a node between the wireless extender and the access point.

For at least some embodiments, the extender 110 includes a controller. For at least some embodiments, the controller is operative to monitor a link quality of the wireless link between the wireless extender and the access point, detect when the link quality is less than a threshold, and select one or more recommendations when the link quality is detected to be less than the threshold based upon a determined feasibility of each of a plurality of possible recommendations, wherein the plurality of possible recommendations includes moving the wireless extender, moving the access point, and adding a node between the wireless extender and the access point.

For at least some embodiments, the threshold (t) is determined by the extender by identifying and classifying a data stream being forwarded, estimating a performance required by the data stream, and setting the threshold (t) to exceed the performance required.

For at least some embodiments, monitoring the link quality includes generating a single measurement of the link quality, and generating a combined measurement of a plurality of measurements. For at least some embodiments, the link quality fluctuates quite a bit (greater than a threshold) over time, so instantaneous measure may not be sufficient. At least some embodiments include determining an average value of link quality (such as, SNR), but also standard deviation, depth of signal fades, duration of fades, etc. The average, standard deviation, depth of signal fades, and/or duration of fades allows for estimating how reliable the link is over a longer duration, not just at that instant.

For at least some embodiments, the selecting of one or more recommendations when the link quality is determined to have failed a link quality test includes selecting the one or more recommendation based upon effects of each of the plurality of possible recommendations on other devices 112, 114, 116 connected to the wireless extender 110. That is, the other devices 112, 114, 116 may be wire or wirelessly connected to the extender 110. Further, moving the extender 110 can have varying impacts on the other devices 112, 114, 116.

For at least some embodiments, one or more of the devices 112, 114, 116 are fixed. That is, the fix devices are not moveable. Further, these fixed devices may still require good connection quality to the extender 110. If moving the extender 110 negatively impacts the connection quality, then moving the extender may not be the best recommendation. Further, if there are fixed (immovable) devices that are wire-connected (for example, through a cable) to the extender 110, then moving the extender 110 may not be an option. However, if there are only mobile or movable devices connected to the extender, then the extender can be moved without causing permanent impairment of the connection quality to these devices.

FIG. 2 shows a wireless mesh network that includes an access point and an extender, according to an embodiment. The wireless mesh network includes multiple access nodes 220, 221, 222. As shown, the extender 110 maintains a connection to the network 130 through multiple access points 221, 220.

For at least some embodiments, the extender 110 monitors the link quality (LQ) between the extender 110 and the upstream access point 220. Within the mesh network, the upstream access point 220 includes another upstream access point 221. Within the mesh network, the upstream access point 220 may be an access point, an access node, a gateway, etc. For at least some embodiments, the extender 110 monitors the connection quality, which for an embodiment of the wireless mesh network includes a path quality between the extender 110 and the upstream access point. For example, the upstream access point may be access point 221. Accordingly, the path quality includes one more of the links between the extender 110 and the upstream access point 221. That is, the path quality may include the link between the extender 110 and the access point 222, between the access point 222 and the access point 223, between the access point 223 and the access point 221. Various methods of estimating the path quality are described.

For at least some embodiments, selecting of one or more recommendations includes selecting the one or more recommendation based upon physical constraints associated with the upstream node of the wireless mesh network. For an embodiment, as shown in FIG. 1, this includes devices 122, 124 and extender 150 connected to the wireless access point 120. For an embodiment, as shown in FIG. 2, this includes an upstream access point 222 connected to the access point 220.

For at least some embodiments, the selecting of the one or more recommendations includes selecting the one or more recommendation based upon effects of each of the plurality of possible recommendations on other devices connected to the upstream node of the wireless mesh network.

For at least some embodiments, the extender 110 (or a controller within the extender 110) is operative to monitor a path quality between the wireless extender and a node of the wireless mesh network that is multiple wireless links upstream from the wireless extender, determine when the path quality fails a path quality test, and select the one or more recommendations when the path quality fails a path quality test.

### Mesh Topology and Terminology

Wireless mesh networks include multiple devices, referred to as mesh nodes, connected to each other through wireless links. Mesh nodes typically employ a mesh routing protocol that allows nodes to discover each other and select routing paths between each other and out to the Internet.

An example of a wireless mesh network is depicted in FIG. 2. Access point 221 is connected to the Internet 130 through, for example, a cable modem 270. Wireless mesh nodes 220, 222, 223 are wirelessly connected through wireless links. Access point 221 may be considered a mesh node if it participates in a mesh routing protocol. It may also be considered a mesh gateway, since it has a direct connection to the Internet 130 through a wired link to the cable modem 270. Wireless mesh nodes 220, 222, 223 have no direct wired connection to the Internet, but are connected to the Internet through wireless links or paths that extend through the gateway node 221. For example, mesh node 220 has a path to the Internet that passes through mesh node 223, and mesh gateway 221. Since the path for node 220 includes a chain of two wireless links, it is referred to as being 2 hops away from the gateway 221. Since the path for node 220 traverses mesh nodes 223 and 221, the nodes 223 and 221 are referred to as upstream mesh nodes for the node 220. Mesh node 223 is the next hop between node 221 and the Internet 130, therefore node 221 it is referred to as the next-hop upstream mesh node for node 223.

Mesh nodes 220, 221, 222, 223 form a wireless mesh topology that has a tree structure, with the mesh gateway 221 forming the root of the tree. Nodes 220 and 222 form the leaves of the tree, since each of 220 and 222 is a terminal node of the tree. 220 and 222 are also referred to as extenders. The terms extender, repeater and mesh node are sometimes used interchangeably in the art, depending on the context. FIG. 2 also shows extender 110.

Each of the wireless mesh nodes, including nodes 220 and 222, can also function as a wireless access point, and provide connectivity to wireless client devices such as smartphones. Device 122 (which could be a Smartphone) is connected to mesh node 221, which is also a wireless access point. Devices (which could also be a Smartphone) is connected to mesh node 222, which is also a wireless access point.

Mesh networks are dynamic and the connectivity topology may change over time as nodes are added and removed. The network topology can also change due to changes in the radio environment. Wireless effects such as shadowing, fading, interference, noise, etc. can result in changes in the qualities of individual links. Mesh nodes typically run a dynamic routing protocol to evaluate and select the best routes or the best paths through a wireless mesh network and these selections change over time as conditions change.

FIG. 2 illustrates a wireless mesh network and an extender node 110. For an embodiment, the extender node 110 can be added to a mesh network and become a part of the mesh network. The wireless mesh network includes mesh nodes 220, 221, 222, 223 and the extender mesh node 110 is added to the mesh network. For an embodiment, the mesh node 221 is a gateway node, since it is directly connected to Internet 130 through, for example, the cable modem 270 providing a backhaul connection. Mesh nodes 223 and 221 are upstream mesh nodes for extender 110. Mesh node 220 is a next-hop upstream mesh node for extender 110. Mesh nodes, such as nodes 221 and 22, can also act as wireless access points, serving to connect client devices such as Devices 122 and 152 (which may be smartphone).

An extender, or a new mesh node that is newly added, can connect to the wireless mesh. It can then act as an access point (AP) itself, so that client devices can connect directly to the extender. In this way, an extender augments and extends the wireless coverage.

When an extender is used to extend the coverage of an existing mesh network, it is desirable for it to measure and report the connection quality between it and the mesh network, and to provide recommendations on a display of ways to improve the connection quality. It is desirable for the connection quality metrics to comprise metrics for the extender's last-hop link as well as for the extender's end-to-end path through the mesh network.

As previously described, for at least some embodiments, an extender measures a connection quality to a mesh network. There are multiple ways of assessing a connection quality between the extender and the mesh.

For an embodiment, the extender measures a connection quality for a wireless link between the extender and a next-hop upstream mesh node. For an embodiment, the extender measures the Signal to Noise Ratio (SNR) of frames received from a next-hop upstream mesh node. For an embodiment, these frames are data frames. For an embodiment, these frames are routing packets. For an embodiment, these frames are 802.11 Beacon frames. For an embodiment, the extender measures the Received Signal Strength Indicator (RSSI) of frames received from the AP. For an embodiment, the extender measures a Link Packet Error Rate (LinkPER) or Link Packet Success Probability (LinkPSP) of the link to the AP by sending packets, such as ping packets, to the AP and comparing the number of responses received to the number of packets sent. For an embodiment, the extender measures a LinkPSP based on the number of routing packets or 802.11 Beacons received from the AP in a given time, compared to the number of such routing packets or 802.11 Beacons known to have been transmitted by the AP in that time period. For example, if it is known that the AP transmits 100 packets of a given type in every second, and the extender (on average) only receives 60 such packets per second, then the extender measures a LinkPSP of 60/100=0.6, which is a measure of the quality of the link from the AP to the extender. For an embodiment, the extender transmits packets to the AP allowing the AP to measure the PSP for the link from the extender to the AP. The AP can then report this measurement to the extender. In this way, the extender has a measurement of the ReverseLinkPSP for the link from the extender to the AP. For an embodiment, the extender measures the modulation rates used on packets sent by the AP as well as the modulation rates for packets sent by the extender. For an embodiment, the extender estimates the throughput on the link from the AP to the extender based on the packet error rate and the modulation rate used on the link. For an embodiment, the extender estimates the Uplink Expected Transmission Time (UL-ETT) on the link from the extender to the AP based on the ReverseLinkPSP and the modulation rate used by the extender. For an embodiment, the extender estimates the Downlink Expected Transmission Time (DL-ETT) on the link from the AP to the extender based on the LinkPSP and the modulation rate used in packets transmitted by the AP. For an embodiment, the extender estimates a Round-Trip ETT (RT-ETT) by summing the Expected Transmission Times for the Uplink and the Downlink: RT-ETT=DL-ETT+UL-ETT. For an embodiment, the extender measures the throughput on the link between the extender and the AP by performing a throughput test (such as Iperf or nuttcp) to the extender. For an embodiment, the extender measures the latency of the link to the AP by measuring and averaging the round-trip time for ping packets sent to the AP and ping responses received from the AP.

For an embodiment, the extender measures a connection quality for a routing path between the extender and a gateway node. For an embodiment, the extender measures a Path Packet Success Probability (PathPSP) for a routing path between the extender and a gateway node for the mesh network. For an embodiment the PathPSP is measured through a gateway node originating a specified number of packets in a specified duration, intermediate mesh nodes forwarding the packets as they are received, and the extender mesh node measuring the number of packets received and comparing that number to the number that were transmitted by the gateway node. For an embodiment the packets originated by a gateway node are routing packets. For an embodiment the packets originated by a gateway node are data packets. For an embodiment the packets originated by a gateway node are control packets. For an embodiment the packets originated by a gateway node are broadcast frames. For an embodiment the packets originated by a gateway node are unicast frames.

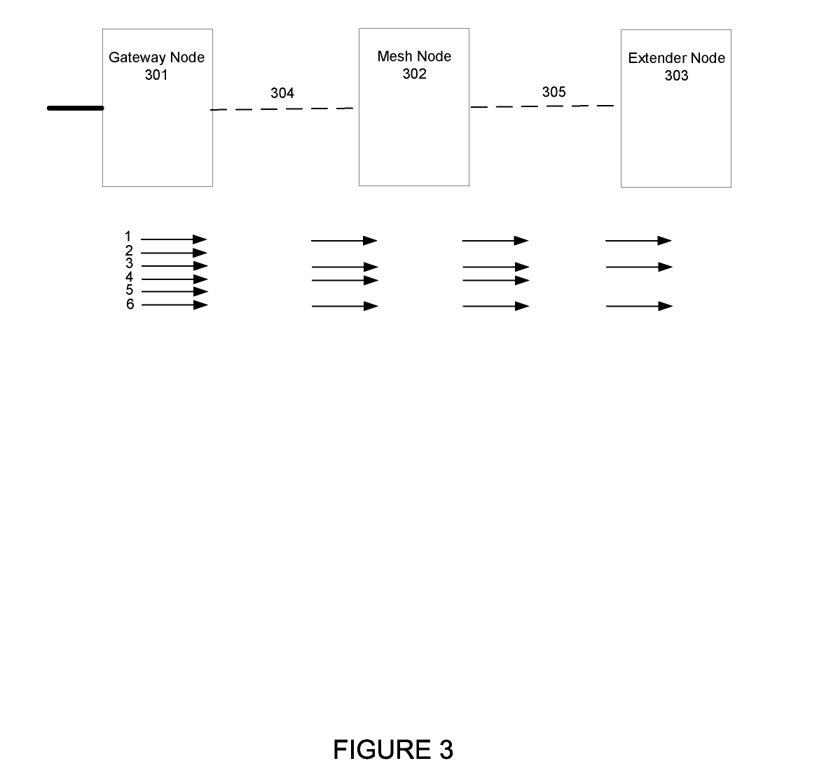

FIG. 3 shows a measurement of the quality of a communications path through a wireless mesh network, according to an embodiment. Specifically, FIG. 3 shows a measurement of PathPSP. As shown, a Gateway node 301 originates 6 packets in a specified duration. A Mesh node 302 successfully receives packets 1, 3, 4, and 6, but packets 2 and 5 are not successfully received. Packet errors and losses are common on wireless links such as link 304. The Mesh node 302 forwards packets 1, 3, 4 and 6 over the wireless link 305. Packets 1, 3 and 6 are successfully received by extender node 303, but packet 4 is not successfully received. Since extender node 303 only received 3 packets out of 6 packets originated by gateway 301, the extender node 303 measures a PathPSP of 3/6=0.5.

For an embodiment, the extender measures a Reverse Path Packet Success Probability (ReversePathPSP) for the routing path through the mesh network to a gateway node. For an embodiment the PathPSP is measured through the extender node originating a specified number of packets in a specified duration, intermediate mesh nodes forwarding the packets towards the gateway node as they are received, the gateway node measuring the number of packets received and comparing that number to the number that were transmitted by the extender node, and the gateway node reporting back to the extender node the fraction of packets successfully received. For an embodiment the packets originated by the extender node are routing packets. For an embodiment the packets originated by the extender node are data packets. For an embodiment the packets originated by the extender node are control packets. For an embodiment the packets originated by the extender node are broadcast frames. For an embodiment the packets originated by the extender node are unicast frames.

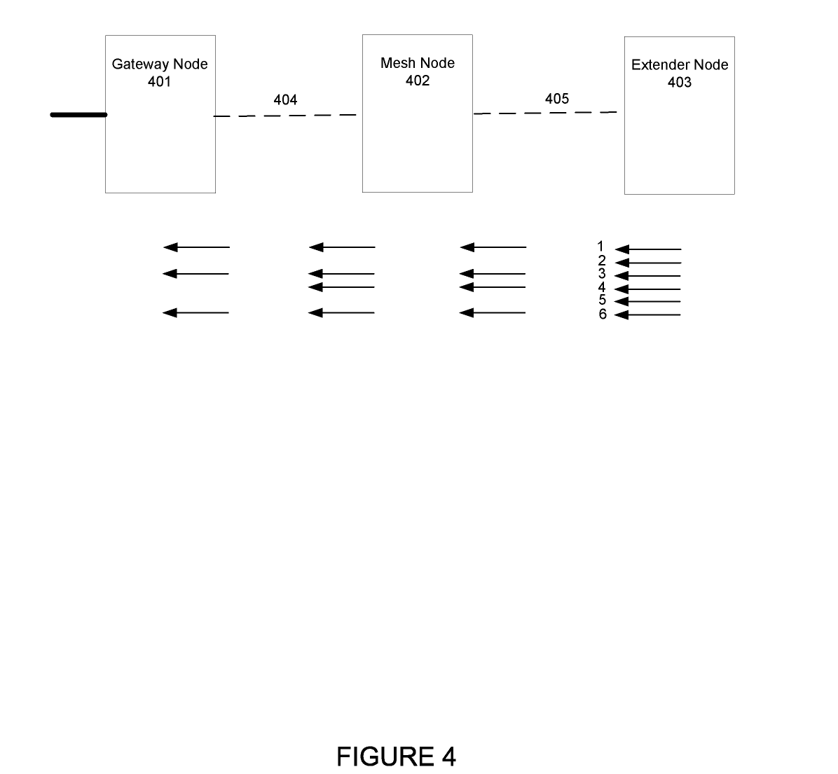

FIG. 4 shows a measurement of the quality of a reverse communications path through a wireless mesh network, according to an embodiment. Specifically, FIG. 4 shows a measurement of ReversePathPSP. An Extender node 403 originates 6 packets in a specified duration. A Mesh node 402 successfully receives packets 1, 3, 4, and 6, but packets 2 and 5 are not successfully received. Packet errors and losses are common on wireless links such as link 405. The Mesh node 402 forwards packets 1, 3, 4 and 6 over the wireless link 404. Packets 1, 3 and 6 are successfully received by gateway node 401, but packet 4 is not successfully received. Since gateway node 401 only received 3 packets out of 6 packets originated by extender 403, it measures a ReversePathPSP of 3/6=0.5. Finally, the gateway 401 transmits this measurement of ReversePathPSP to extender 403.

For an embodiment, the extender measures a round-trip latency for the routing path through the mesh network to a gateway node. The round trip latency may be measured by the extender transmitting packets, such as ping packets, to the gateway node, and measuring the round trip response time between the time of transmission of the ping packets (ICMP Request messages) and the time of reception of the corresponding ping response packets (ICMP Response messages). For an embodiment, the extender measures a downlink or uplink expected transmission time for packets on the routing path to the gateway. For an embodiment, the extender measures an end-to-end expected transmission time for packets on the routing path to the gateway. For an embodiment, an uplink expected transmission time is measured by comparing the time of transmission of packets by the extender node to the time of reception of the corresponding packets by the gateway node. For an embodiment, a downlink expected transmission time is measured by comparing the time of transmission of packets by the gateway node to the time of reception of the corresponding packets by the extender node. For an embodiment, a roundtrip expected transmission time is measured by comparing the time of transmission of packets by the extender node to the time of reception of the corresponding packets by the extender node after having been received and sent back by the gateway node. For an embodiment, a roundtrip expected transmission time is measured by adding an uplink expected transmission time and a downlink expected transmission time on a routing path.

For an embodiment, the extender measures an instantaneous (real-time) connection quality to the mesh network. For an embodiment, the extender measures a connection quality to the mesh network over a period of time, T. For an embodiment, the period of time T could be much larger than a second—for example T could be several minutes, hours or days. For an embodiment, the extender measures an average of the connection quality over a period of time, T. For an embodiment, the extender compares the measured average connection quality to a performance threshold to determine if the connection quality exceeds or falls below the performance threshold. For an embodiment, the extender measures a number of times (N) within the time period T, that the connection quality drops below the performance threshold. For an embodiment, the extender measures a fraction (f) of the overall time T that the connection quality falls below the threshold. For an embodiment, the extender measures an average duration (D) of events where the connection quality drops down below the performance threshold. For an embodiment, the extender measures a value that the connection quality exceeds at least X percent of the time, where X is a predetermined percentage. For example, if X=95%, the extender measures the value that the connection quality exceeds 95% of the time.

For an embodiment, the extender detects a plurality of events. For an embodiment, the plurality of events includes instantaneous measurements of the connection quality to the mesh network. For an embodiment, the plurality of events includes instances where the connection quality drops below a performance threshold. For an embodiment, the plurality of events includes instances where the connection quality exceeds a performance threshold.

For an embodiment, the extender determines when the connection quality to the mesh network fails a connection quality test based on the plurality of detected events. For an embodiment, the plurality of detected events includes instances where the connection quality drops below a performance threshold, and the connection quality test is deemed to have failed if the number of detected events within a specified duration exceeds an allowable maximum number. For an embodiment, the plurality of events includes instantaneous measurements of the connection quality, and the connection quality test is deemed to have failed if the average of the instantaneous connection quality measurements over a specified duration falls below a minimum threshold value. For an embodiment, the plurality of events includes a sequence of instantaneous measurements of the connection quality within a specified time interval, and the connection quality test is deemed to have failed if the number of instantaneous connection quality measurements within that time interval that fall below a threshold value (t) exceed a threshold fraction (f) of the overall number of instantaneous measurements within that time interval. For an embodiment, the plurality of events includes a sequence of instantaneous measurements of the connection quality within a specified time interval, and the connection quality test is deemed to have failed if the number of consecutive connection quality measurements within that time interval that fall below a threshold value (t), exceed a threshold number.

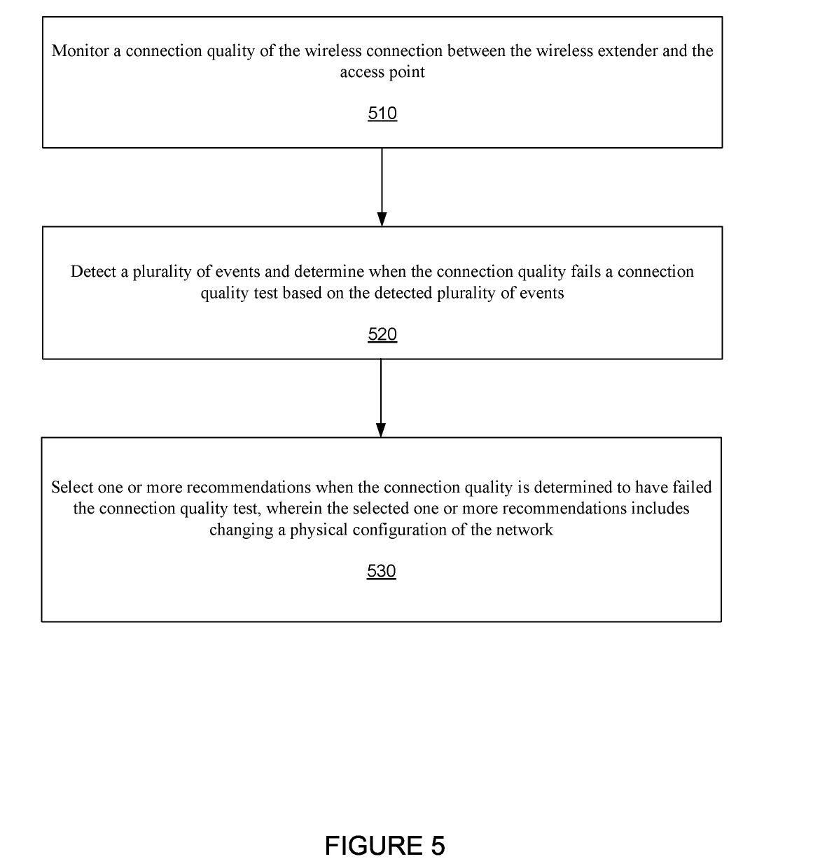

FIG. 5 is a flow chart that includes steps of a method of monitoring and maintaining a wireless connection quality between an extender and an access point, according to an embodiment. A first step 510 includes monitoring a connection quality of the wireless connection between the wireless extender and the access point. The connection quality may be assessed in various ways. For an embodiment, the extender measures the received signal strength (RSS) on packets from a next-hop upstream mesh node. For an embodiment, the extender measures the signal to noise ratio (SNR) of packets from a next-hop upstream mesh node. A second step 520 includes detecting a plurality of events and determining when the connection quality fails a connection quality test based on the detected plurality of events. For an embodiment, the extender compares the average value of the RSS or the SNR from the next-hop upstream mesh node to a threshold value for the RSS or SNR to determine if the received signal strength is weak on average, and the connection quality test is deemed to have failed if the average RSS or SNR is below a threshold. For an embodiment, the extender compares the median (50th percentile) or any other percentile of the RSS or SNR from a next-hop upstream mesh node to a threshold to determine if the received signal strength is reliably or consistently above a threshold value for the RSS or SNR to determine if the connection quality passes or fails this connection quality test. For example, if the RSS falls below −70 dBm over 10% of the time, it might imply that video streaming and downloads will experience hiccups that affect the user experience. A third step 530 includes selecting one or more recommendations when the connection quality is determined to have failed the connection quality test, wherein the selected one or more recommendations includes changing a physical configuration of the network. For an embodiment, changing a physical configuration of the network includes moving the wireless extender. For an embodiment, changing a physical configuration of the network includes moving the access point. For an embodiment, changing a physical configuration of the network includes adding a node between the wireless extender and an upstream mesh gateway. For at least some embodiments, an additional step includes if the connection quality is below a performance threshold, the extender providing the recommendation through at least one of a text-based recommendation presented on a display, a graphical recommendation presented on a display, an audio recommendation played through a speaker.

For at least some embodiments, the connection quality includes a link quality between the wireless extender and an upstream access point. For at least some embodiments, the connection quality includes a path quality between the wireless extender and an upstream access point, wherein the upstream access point is multiple wireless hops upstream from the wireless extender.

For at least some embodiments, detecting the plurality of events includes detecting instances when the connection quality drops below a performance threshold, and the connection quality is determined to have failed the connection quality test if the number of detected events within a specified duration exceeds an allowable maximum number. For at least some embodiments, detecting the plurality of events includes detecting instantaneous measurements of the connection quality, and the connection quality test is deemed to have failed if an average of the instantaneous connection quality measurements over a specified duration falls below a minimum threshold value. For at least some embodiments, detecting the plurality of events includes detecting a sequence of instantaneous measurements of the connection quality within a specified time interval, and the connection quality test is deemed to have failed if a number of connection quality measurements within that time interval that fall below a threshold value (t), exceed a threshold number.

As previously stated, for at least some embodiments, changing the physical configuration includes selecting one or more of moving the wireless extender, moving the access point, and adding a node between the wireless extender and the access point.

For at least some embodiments, selecting the one or more recommendations when the link quality is determined to have failed a link quality test includes determining a feasibility of each of a plurality of possible recommendations.

At least some embodiments include a feedback mechanism that provides an indication of the link quality to a user. For at least some embodiments, the recommendation is provided to a user of the wireless extender on the display. For at least some embodiments, the recommendation is provided to a user of the wireless extender. At least some embodiments include providing real-time updates of the indication of the link quality while the wireless extender is in motion.

As previously described, for at least some embodiments, selecting of one or more recommendations when the link quality has failed a link quality test includes selecting the one or more recommendation based upon physical constraints associated with the wireless extender. As previously described, for at least some embodiments, selecting of one or more recommendations when the link quality has failed a link quality test includes selecting the one or more recommendation based upon physical constraints associated with the access point.

As previously described, for at least some embodiments, selecting of one or more recommendations when the link quality fails the link quality test includes selecting the one or more recommendation based upon effects of each of the plurality of possible recommendations on other devices connected to the wireless extender.

As previously described, for at least some embodiments, the selecting of one or more recommendations when the link quality fails the link quality test includes selecting the one or more recommendation based upon effects of each of the plurality of possible recommendations on other devices connected to the access point.

As previously described, the described embodiments can also be adapted for use within a wireless mesh network. That is, for at least some embodiments, the access point is an upstream node of a wireless mesh network. Further, as previously described, for at least some embodiments, the selecting of one or more recommendations when the link quality fails a link quality test includes selecting the one or more recommendation based upon physical constraints associated with the upstream node of the wireless mesh network. Further, as previously described, for at least some embodiments, the selecting of one or more recommendations when the link quality has failed a link quality test includes selecting the one or more recommendation based upon effects of each of the plurality of possible recommendations are other devices connected to the upstream node of the wireless mesh network.

For at least some embodiments, the wireless extender is operative to monitor a path quality between the wireless extender and a node of the wireless mesh network that is multiple wireless links upstream from the wireless extender, detect when the path quality fails a path quality test, and select the one or more recommendations when the path quality fails a path quality test.

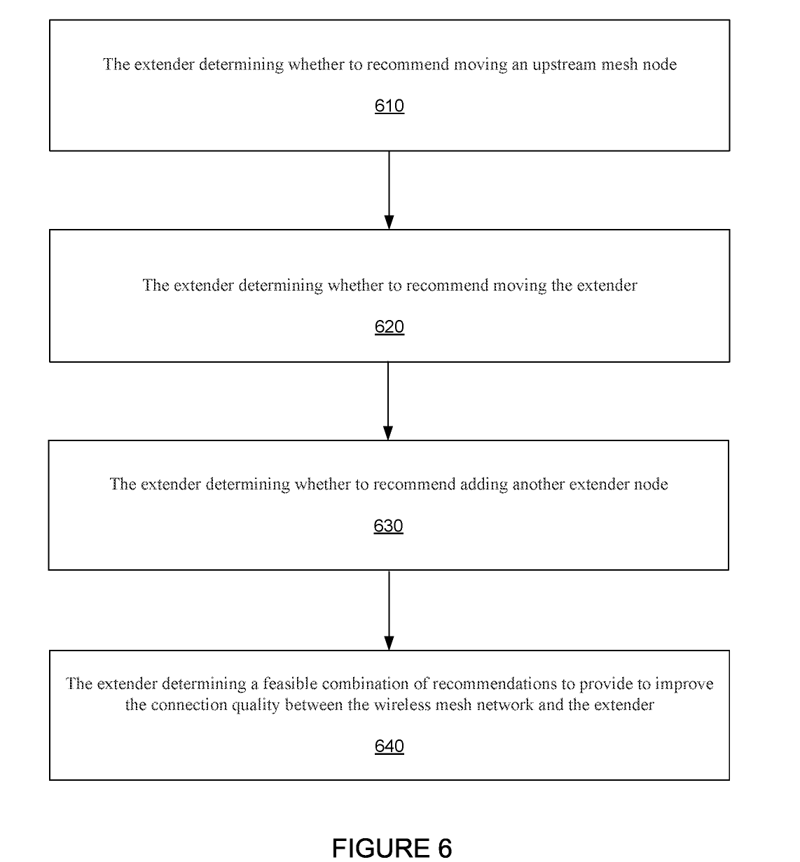

FIG. 6 is a flow chart that includes steps of a method of determining wireless network recommendations to improve link quality in a network that includes an extender and a wireless mesh network, according to an embodiment. For an embodiment, the wireless network recommendations include changing a physical configuration of the network. For an embodiment, changing a physical configuration of the network includes moving an upstream mesh node. For an embodiment, changing a physical configuration of the network includes moving the extender. For an embodiment, changing a physical configuration of the network includes adding another extender. A first step 610 includes the extender determining whether to recommend moving an upstream mesh node. For an embodiment, the extender may query a next-hop upstream mesh node to determine whether it is capable of being moved and determine whether to recommend moving the next-hop upstream mesh node based on whether the next-hop upstream mesh node is capable of being moved. A second step 620 includes the extender determining whether to recommend moving the extender. For an embodiment, the extender may recommend moving the extender (i.e., recommending itself be moved) if it determines it is capable of being moved. A third step 630 includes the extender determining whether to recommend adding another extender node. A fourth step 640 includes the extender determining a feasible combination of recommendations to provide to improve the connection quality between the wireless mesh network and the extender.

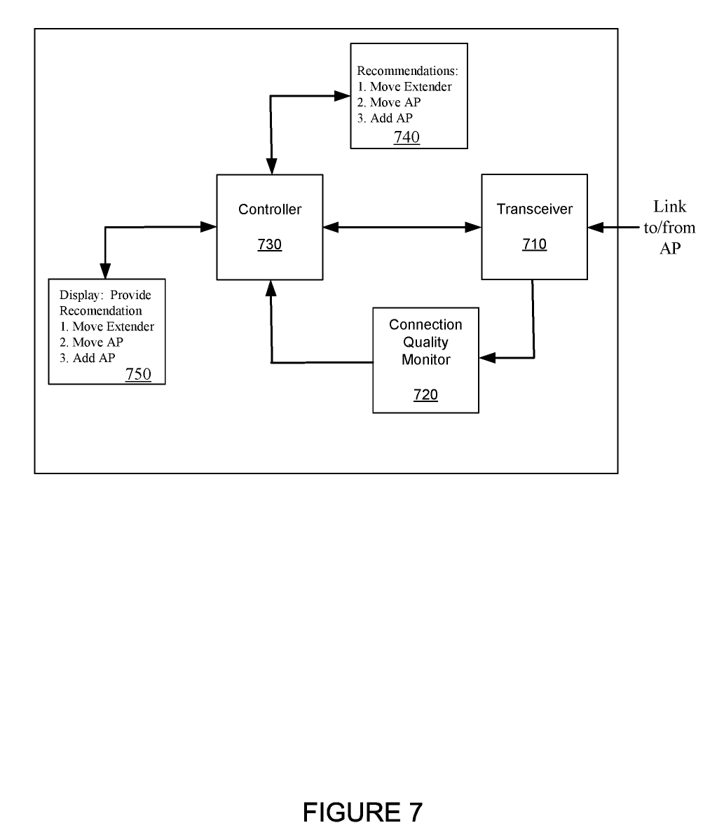

FIG. 7 shows a block diagram of an extender, according to an embodiment. For at least some embodiments, the extender includes a transceiver 710 for supporting wireless communication with an upstream access point. The transceiver is coupled to a controller 730. A connection 720 quality monitor provides an estimate or measurement of the link quality of the link between the transceiver 710 the upstream access point. The controller monitors the link quality, detects a plurality of events, and, if it determines if the link quality fails a link quality test, the controller selects an action to alleviate or mitigate the poor link quality. For an embodiment, if the link quality falls below a threshold, the controller selects one or more recommendations 740. For an embodiment, if the link quality fails a link quality test, the controller selects one or more recommendations. For an embodiment, the recommendations include changing a physical configuration of the network. For an embodiment, changing a physical configuration of the network includes one or more of moving the extender, moving an upstream access point, or adding an upstream access point. Once the one or more recommendations have been selected, for at least some embodiments, the one or more recommendations are provided to a user of the extender. For an embodiment, the extender includes a display 750, and the one or more recommendations are provided to the user of the wireless extender on the display 750. For an embodiment, the extender provides a performance metric on the display

For at least some embodiments, the extender provides a performance metric for a connection between the extender and the mesh network on the display

For an embodiment, the extender directly provides a performance measure of the connection quality to the mesh network on a display that is part of the extender device or is directly attached to the extender device. For an embodiment, the extender directly provides a performance measure of the connection quality to the mesh network on a display of a mobile device.

For an embodiment, the extender provides a performance measure of the connection quality through a text-based message on a display attached to the extender. For an embodiment, the extender provides a performance measure of the connection quality through a visual or graphical indication on a display attached to the extender. For an embodiment, the extender provides a performance measure of the connection quality through an audio-based message played through an audio speaker attached to the extender.

For an embodiment, the performance measure is a connection quality of a wireless link between the extender and a next-hop upstream mesh node. For an embodiment, the performance measure is a connection quality of a routing path between the extender and a gateway node of the mesh network. For an embodiment, the performance metric reflects whether the connection quality exceeds a minimum performance threshold. For an embodiment, the extender periodically updates the displayed performance metric over time.

For an embodiment, the extender provides a recommendation to allow an operator to improve the connection quality to a mesh network.

If the connection quality between an extender and a mesh network is not strong enough, it is likely to result in poor network performance for the end user. Even if the user or the client device has a strong connection to the extender, the overall Internet connectivity across the multiple wireless links may be weak because one or more of the links in the routing path between the extender and a gateway node is a weak link. In such a case, the user may experience dropped calls, degraded video quality, pages that fail to load, etc.

For an embodiment, the extender actively measures the connection quality between it and a next-hop upstream mesh node, and indicates it on a display. For an embodiment, the extender actively measures the connection quality between it and the mesh network, and indicates it on a display. For an embodiment, the displayed measure indicates if the connection quality is poor, or unreliable, or below a performance threshold. For an embodiment, the extender determines if there are steps the user could take to improve the connection quality. For an embodiment, the extender provides recommendations to the user to enable him or her to take the necessary steps to improve the connection quality.

For an embodiment, the recommendation is provided on a display screen attached to the extender. For an embodiment, the recommendation is provided on a display screen of a mobile device.

For an embodiment, the recommendation is provided on a display attached to the extender through a text-based message that indicates to the user a step to take to improve the connection quality. For an embodiment, the recommendation is provided on a display attached to the extender through a visual icon or indication. For an embodiment, the recommendation is provided through an audio-based message that is played out through an audio speaker that is attached to the extender.

For an embodiment, the recommendation includes suggesting to the user to move the extender closer to a next-hop upstream mesh node. For an embodiment, the recommendation includes suggesting to the user to add a mesh node between the next-hop upstream mesh node and the extender. For an embodiment, the recommendation includes suggesting to the user to move a next-hop upstream mesh node closer to the extender.

As previously described, for an embodiment, the display of the extender provides a performance measurement on the display. For example, if the extender is within a wireless mesh network, the display may provide a measure of the connection quality: “Connection Quality: 50%”. The display may also provide a recommendation through a text-based message: “Move Extender closer to the next-hop upstream node 1104”.

It is desirable for the extender to directly reflect the connection quality to the AP on a display. Mesh nodes and extenders are available today for the enterprise market, and they may reflect the connection quality on a wireless network management system dashboard that is accessible by a network IT administrator on a server.

For an embodiment, the extender directly provides a performance measure of the connection quality on a display that is part of the extender device or is directly attached to the extender device. For an embodiment, the extender directly provides a performance measure of the connection quality on a display of a mobile device. For an embodiment, the extender provides a performance measure through a text-based message on a display that is attached to the extender. For an embodiment, the extender provides a performance measure through a visual or graphical indicator on a display that is attached to the extender. For an embodiment, the extender provides a performance measure through an audio-based message played out on an audio speaker that is attached to the extender.

For an embodiment, the performance measure is a connection quality of a wireless link between the extender and the AP. For an embodiment, the performance metric reflects whether the connection quality between the extender and the AP exceeds a minimum performance threshold. For an embodiment, the extender periodically updates the displayed performance metric over time.

In this way, the needed information is present directly on the device and the user is free to walk around with the device while monitoring the performance metric. When he or she finds an appropriate spot within the room where the performance metric or the connection quality is strong, they can find a nearby power outlet to plug the device into. This is a much simpler process, with fewer steps, and does not require the home user to be an experienced IT professional in order to optimally place an extender within their home.

For an embodiment, the extender provides a recommendation to allow an operator to improve the connection quality

If the connection quality between an extender and an access point is not strong enough, it is likely to result in poor network performance for the end user. Even if the user or the client device has a strong connection to the extender, the overall Internet connectivity across the multiple wireless links may be weak because the link between the extender and the AP is weak. In such a case, the user may experience dropped calls, degraded video quality, pages that fail to load, etc.

Referring back to FIG. 1, an access point 120 is connected to the Internet 130 through a cable modem 160. A wireless device (such as, smartphone) 112 is connected to an extender 110 through a wireless link. The extender 110 is connected to the access point 120 through another wireless link having a link quality (LQ). In some situations, the link between access point 120 and extender 110 has a poor connection quality (low LQ). This could be due to a number of factors including the extender 110 having been placed too far away from the access point 120. However, the link between the extender 110 and smartphone 112 has a good connection quality, but the smartphone 112 still experiences poor network performance in this example, since its connection to the Internet has to go through wireless link having the low LQ. For example, if there is a high percentage of packet errors on the link between the extender 110 and the access point 120 that has the low LQ, this automatically affects any traffic to or from smartphone 112.

For an embodiment, the extender actively measures the connection quality between it and the access point, and indicates it on a display. For an embodiment, the displayed measure indicates if the connection quality is poor, or unreliable, or below a performance threshold. For an embodiment, the extender determines if there are steps the user could take to improve the connection quality. For an embodiment, the extender provides recommendations to the user to enable him or her to take the necessary steps to improve the connection quality. For an embodiment, the recommendation is provided on a display screen attached to the extender. For an embodiment, the recommendation is provided on a display screen of a mobile device. For an embodiment, the recommendation is provided on a display through a text-based message that indicates to the user a step to take to improve the connection quality. For an embodiment, the recommendation is provided on a display through a visual icon or indication. For an embodiment, the recommendation is audio-based, and is played through a speaker attached to the extender. For example, the extender's audio speaker could play a message using a synthesized human voice.

For an embodiment, the recommendation includes suggesting to the user to change a physical configuration of the network. For an embodiment, the recommendation includes suggesting to the user to move the extender closer to the access point. For an embodiment, the recommendation includes suggesting to the user to add a mesh node between the access point and the extender. For an embodiment, the recommendation includes suggesting to the user to move the access point closer to the extender.

For at least some embodiments, the recommendations are provided by one or more feedback mechanisms to the user of the extender. For an embodiment, the feedback mechanism includes textual recommendation (for example, a text-based message displayed on-screen) or a visual/graphic recommendation message (for example, icons or an animation) either being communicated directly to the user, or to a mobile device of the user.

For at least some embodiments, the recommendation is included within an indicator that includes at least one or more of a visual display of the link quality, an audible representation of the link quality, or any other implementation that is detectable by the user.

For an exemplary embodiment, the visual feedback includes a signal-strength meter (e.g., something like the graphics below) that is updated in real-time as the user walks around with the extender. Another example of visual feedback is a text message displayed on the screen, such as “Signal Strength: Strong. Place extender close by”.

For another exemplary embodiment, the feedback that includes recommendation includes a binary indicator wherein the binary states include, for example, a green indicator and a red indicator. For this embodiment, if the indicator is green, a present location of the extender is recommended as a good spot to plug in the extender. Further, for this embodiment, if the indicator is red, the recommendation to the user is to keep walking around to find a better location for the extender. For an embodiment that may be a threshold of, say, −70 dBm as desired good signal strength capable of supporting 50 Mbps speeds. However, as an instantaneous measurement may be being made when the user is walking around, the instantaneous measurement may have to be adjusted with an fading margin (e.g., 10-15 dB) to come up with a more conservative estimate of the signal strength at that location. So the algorithm might be: show Green if (Instantaneous signal>threshold signal+fade margin), and show Red otherwise.

For an embodiment, an audio indicator is something like a Geiger counter that beeps at higher pitch or at a higher frequency when connectivity is strong, and beeps slower or lower when connectivity is weak. Another example of audio indicator is a recorded/synthesized voice providing guidance in real-time.

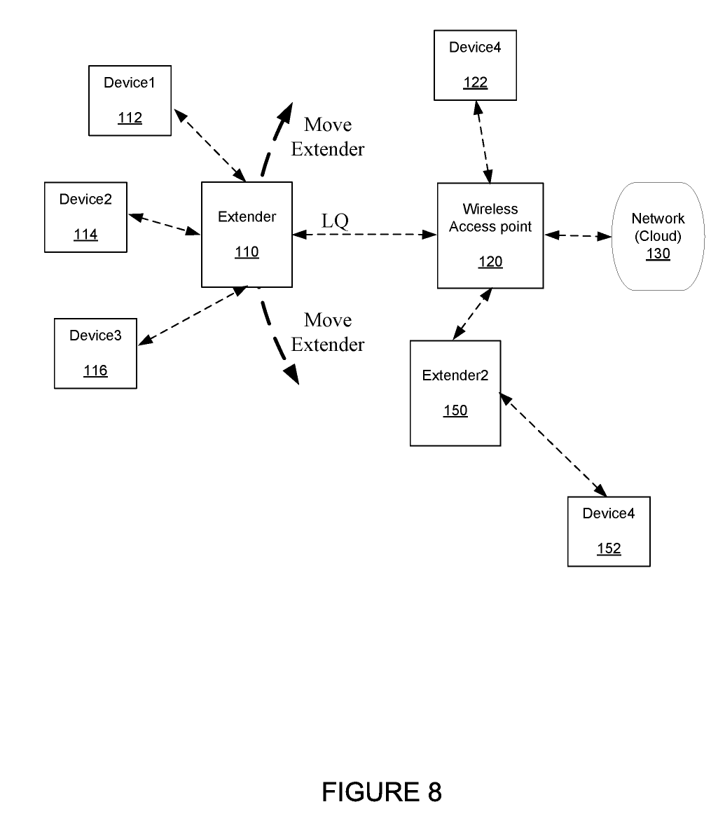

FIG. 8 shows a wireless network that includes an access point 120 and an extender 110, wherein a recommendation to move the extender 110 is selected to improve a link quality between the extender 110 and the access point 120, according to an embodiment. For at least some embodiments, the selecting of one or more recommendations when the link quality fails a link quality test includes selecting the one or more recommendation based upon physical constraints associated with the wireless extender.

For at least some embodiments, the physical constraints include other considerations of other wired and/or wireless devices connected to the extender. For example, wired devices may not be able to accommodate movement of the extender. That is, the wired connections may not have flexibility in movement due to physical constraints of the wired devices. Such physical constraints include the availability of power outlets located proximate to the current location of the wireless extender or the location of power outlets located near to where a desired location of the extender. That is, for at least some embodiments, the extender is powered through a power outlet that is typically included within a wall of a structure in which the extender is located. Therefore, and location of the extender within the structure need to be proximate enough to a power outlet to allow the extender to receive power.

Further, for at least some embodiments, the physical constraints include other consideration of the availability of suitable mounting or placement locations proximate to the current location of the wireless extender and with the right characteristics such as mounting height and clearance.

Further, for at least some embodiments, the physical constraints include other consideration of whether a user of the extender has indicated desire to keep wireless extender at current location, and not move it.

Further, wireless devices may not be able to accommodate movement of the extender because such movement would compromise the quality of the wireless link between the wireless device(s) and the extender.

For at least some embodiments, the extender is operative to provide real-time updates of the indication of the link quality while the wireless extender is in motion.

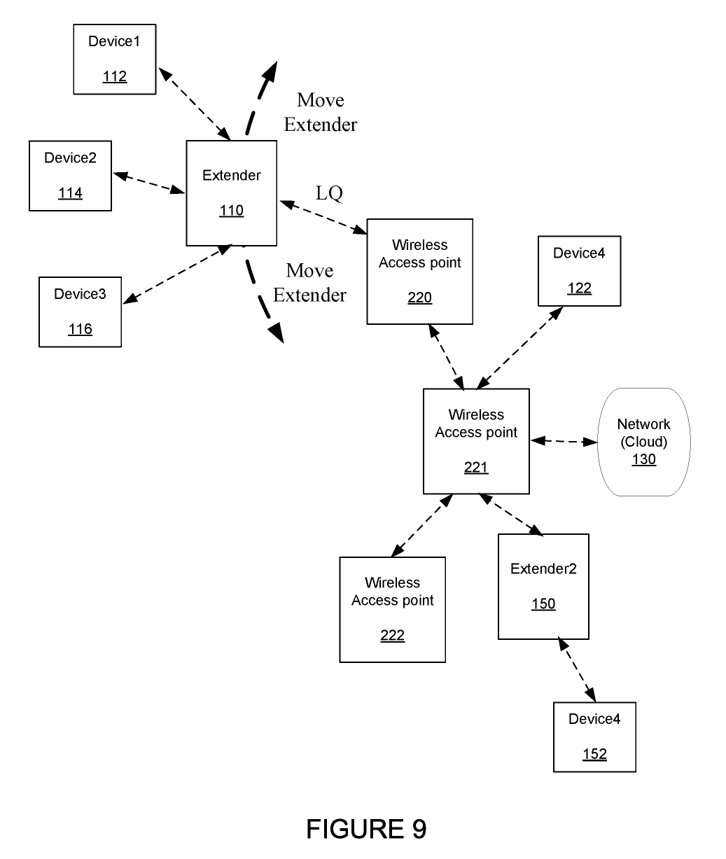

FIG. 9 shows a wireless mesh network that includes access points and an extender, wherein a recommendation to move the extender is selected to improve a link quality between the extender and one of the access points, or a link quality between the extender and an upstream device of the wireless mesh network, according to an embodiment.

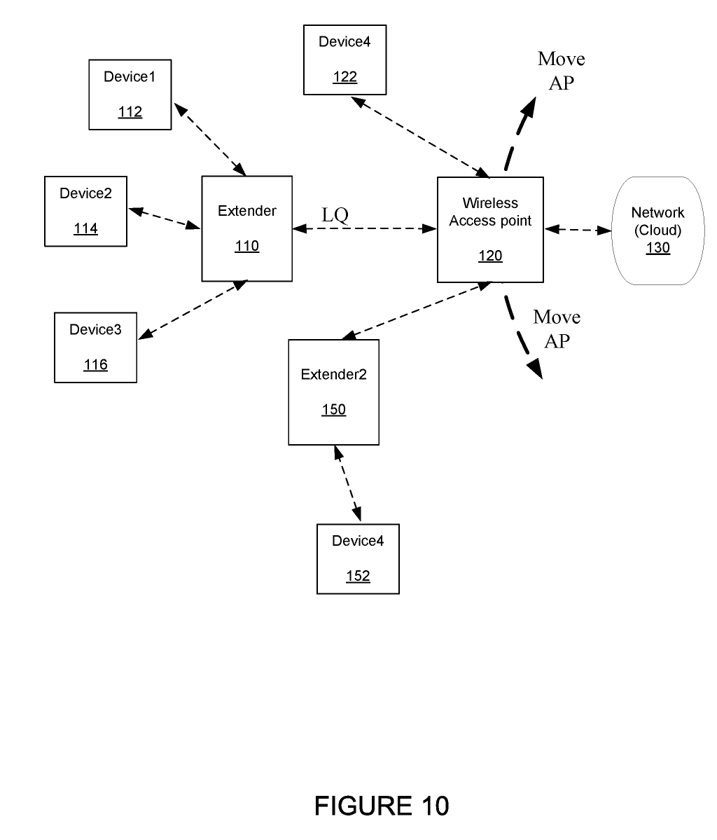

FIG. 10 shows a wireless network that includes an access point and an extender, wherein a recommendation to move the access point is selected to improve a link quality between the extender and the access point, according to an embodiment. As previously described, for at least some embodiments, selecting of one or more recommendations when the link quality fails a link quality test includes selecting the one or more recommendation based upon physical constraints associated with the access point. For at least some embodiments, the physical constraints include the access point being connected to the broadband modem through a cable that restricts range of movement. Further, for at least some embodiments, the physical constraints include the access point may be restricted from being moved due to the access point being connected to other devices through wired or wireless means. Further, for at least some embodiments, the physical constraints include the availability of additional power outlets located proximate to the current location of the access point or located proximate to where a desired location of the access point. Further, for at least some embodiments, the physical constraints include the availability of suitable mounting or placement locations proximate to the current location of the access point and with the right characteristics such as mounting height and clearance. Further, for at least some embodiments, the physical constraints include the whether the access point is currently attached or mounted in a way that makes it harder to detach or dismount. Further, for at least some embodiments, the physical constraints include the user has indicated desire to keep access point at current location, and not move it.

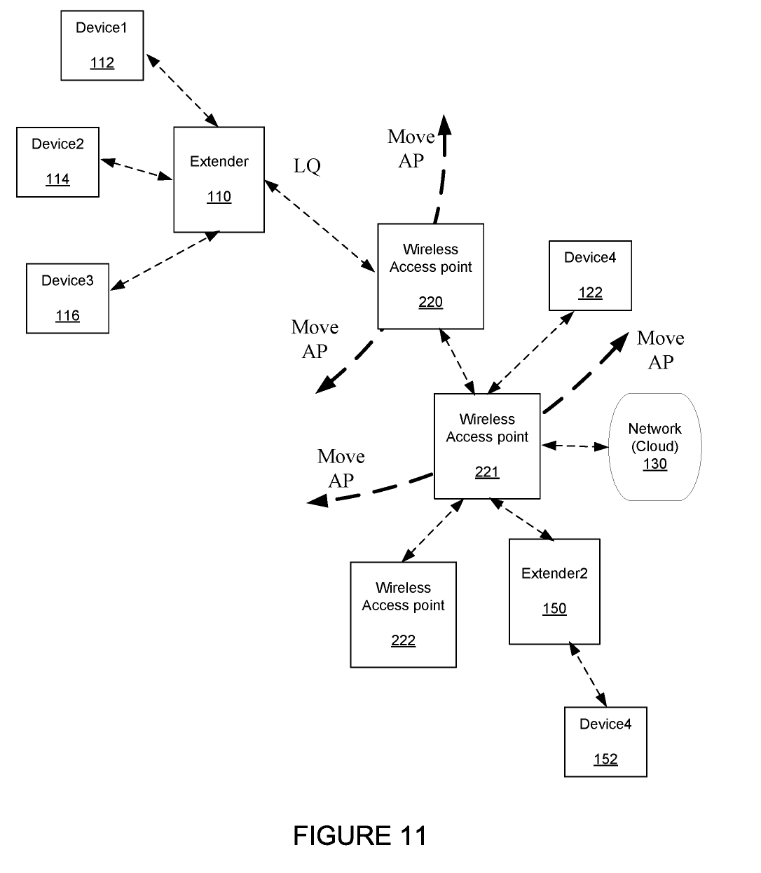

FIG. 11 shows a wireless mesh network that includes access points and an extender, wherein a recommendation to move one or more of the access points is selected to improve a link quality between the extender 110 and one of the access points (such as access point 220), or a link quality between the extender and an upstream device (such as, access point 221 which is a plurality of wireless links upstream from the extender 110) of the wireless mesh network, according to an embodiment.

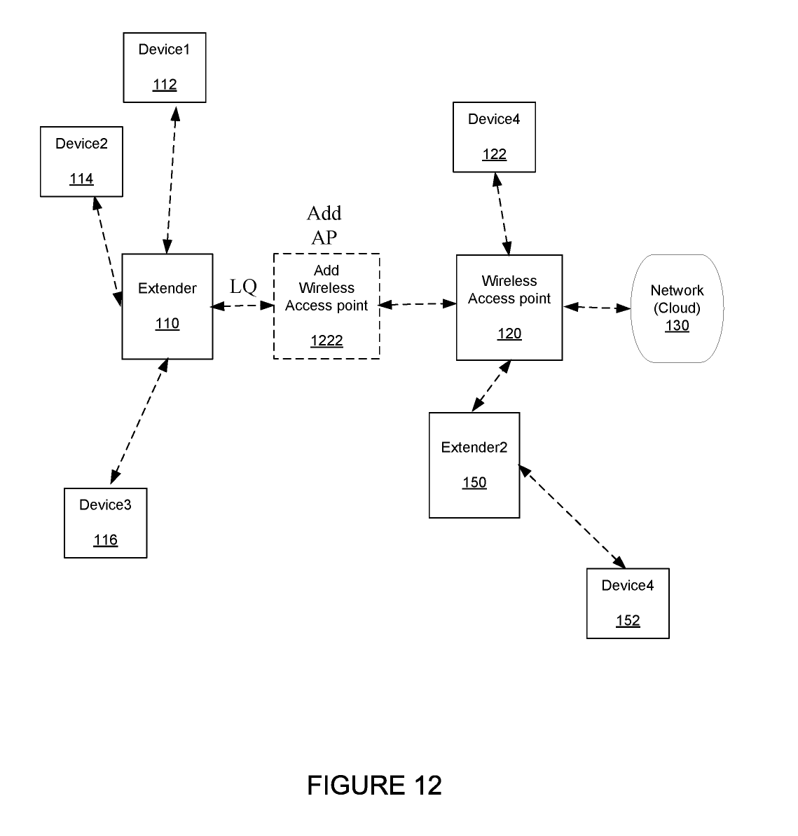

FIG. 12 shows a wireless network that includes an access point and an extender, wherein a recommendation to add another access point 1222 is selected to improve a link quality between the extender and the access point, or a link quality or connection quality between the extender and an upstream device of a wireless mesh network, according to an embodiment. For an embodiment, adding the node 1222 between the wireless extender 110 and the access point 120 includes adding at least one of another wireless extender or another access point between the wireless extender 110 and the access point 120. That is, the node 1222 can be either another extender or another access point.

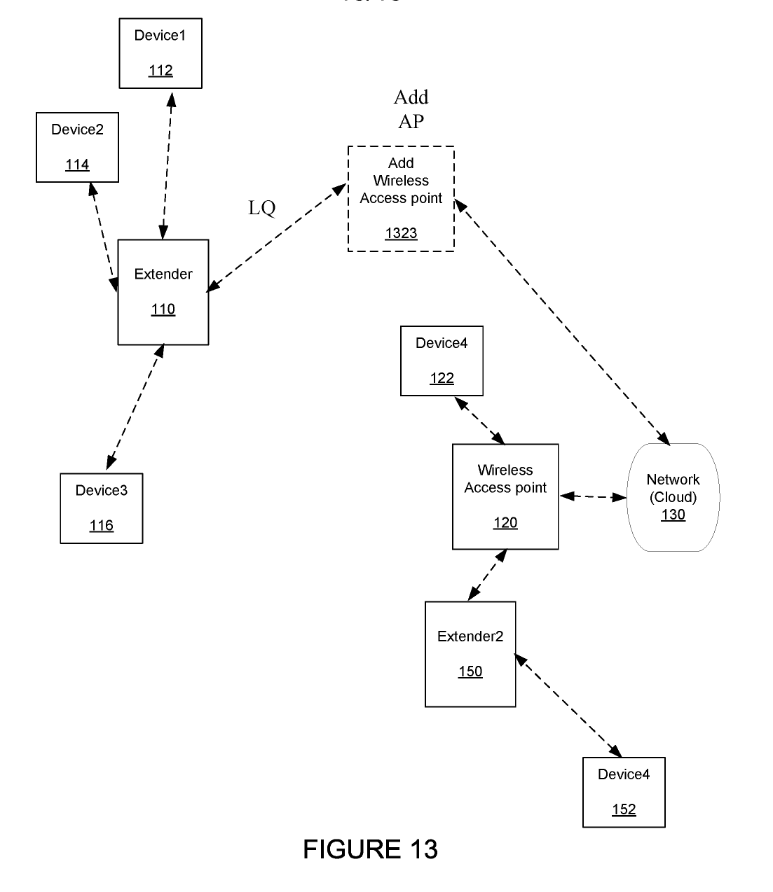

FIG. 13 shows a wireless network that includes an access point and an extender, wherein a recommendation to add another access point 1323 is selected to improve a link quality between the extender and the access point, or a link quality between the extender and an upstream device of a wireless mesh network, according to an embodiment. The addition of the access point 1323 provides the extender 110 with an alternate routing path back to the internet 130.

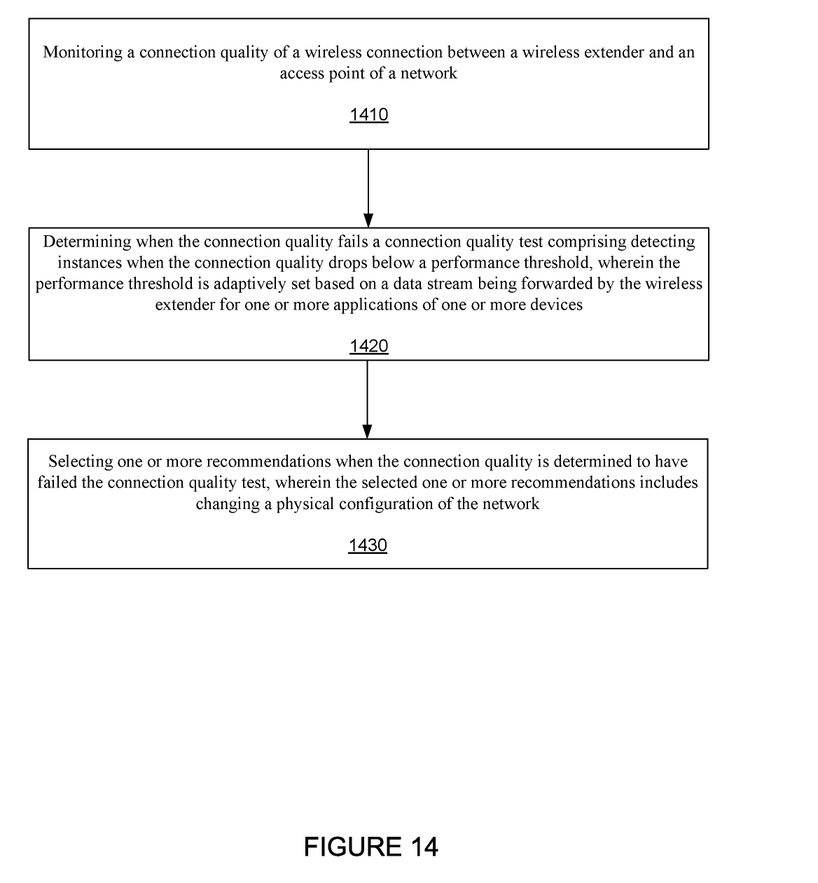

FIG. 14 is a flow chart that includes steps of a method of access point and extender link analysis, data stream analysis, and recommendations. A first step 1410 includes monitoring a connection quality of a wireless connection between a wireless extender and an access point of a network. A second step 1420 includes determining when the connection quality fails a connection quality test comprising detecting instances when the connection quality drops below a performance threshold, wherein the performance threshold is adaptively set based on a data stream being forwarded by the wireless extender for one or more applications of one or more devices. A third step 1430 includes selecting one or more recommendations when the connection quality is determined to have failed the connection quality test, wherein the selected one or more recommendations includes changing a physical configuration of the network.

For an embodiment, the one or more devices includes a plurality of devices, and the one or more applications includes a plurality of applications that are operating on the plurality of devices. Further, the performance threshold is adaptively set based on a plurality of application performance thresholds of the plurality of applications. That is, multiple devices operate with multiple applications, wherein each application results in its own performance threshold. Therefore, there are multiple thresholds that the connection quality test is compared against, to determine if there is a recommendation to be generated. For example, there may be two devices connected to an extender: one running Spotify© at 128 Kbps and the other running Netflix© and needing 5 Mbps. The connection quality may pass the 128 Kbps threshold test for Spotify©, but fail the Netflix© threshold test, and therefore there may be action required, such as, adding another node. An embodiment includes a performance threshold that is adaptively set to account for the individual application performance thresholds. In the above example, the performance threshold may be adaptively set to 5.5 Mbps to account for the individual application performance thresholds of 128 Kbps and 5 Mbps.

For an embodiment, adaptively setting the performance threshold based on a data stream being forwarded by the wireless extender for one or more applications of one or more devices includes adaptively setting the performance threshold based on requirements needed to support the data stream. For at least some embodiment, the data stream forwarded by the wireless extender includes data traffic in both upstream and downstream directions. For at least some embodiments, the data stream is for the one or more applications of the one or more devices coupled directly or indirectly to the wireless extender.

At least some embodiments further include inspecting wireless frames of IP packets of the data stream to identify the data stream between two communication endpoints. The two communication endpoints can each include one or more devices or the cloud (upstream network).

At least some embodiments further include classifying the data stream based on inspection of wireless frames of the data stream, inspection of IP packets of the data steam, or inference based on traffic characteristics of the one or more applications. At least some embodiments further include estimating a minimum performance required by the data stream based on the classification of the data stream. At least some embodiments further include the wireless extender setting the performance threshold based on the estimate of the minimum performance required by the data stream.

As previously described, for at least some embodiments, the connection quality includes a link quality between the wireless extender and an upstream access point. As previously described, for at least some embodiments the connection quality includes a path quality between the wireless extender and an upstream access point, wherein the upstream access point is multiple wireless hops upstream from the wireless extender. As previously described, for at least some embodiments, determining when the connection quality fails a connection quality test comprises detect a plurality of events and determine when the connection quality fails a connection quality test based on the detected plurality of events. As previously described, for at least some embodiments, determining when the connection quality fails a connection quality test comprises detecting a plurality of events and determining when the connection quality fails a connection quality test based on the detected plurality of events. As previously described, for at least some embodiments, detecting the plurality of events includes detecting instantaneous measurements of the connection quality, and the connection quality test is deemed to have failed if an average of the instantaneous connection quality measurements over a specified duration falls below a minimum threshold value. As previously described, for at least some embodiments, detecting the plurality of events includes detecting a sequence of instantaneous measurements of the connection quality within a specified time interval, and the connection quality test is deemed to have failed if a number of connection quality measurements within that time interval that fall below a threshold value (t), exceed a threshold number.

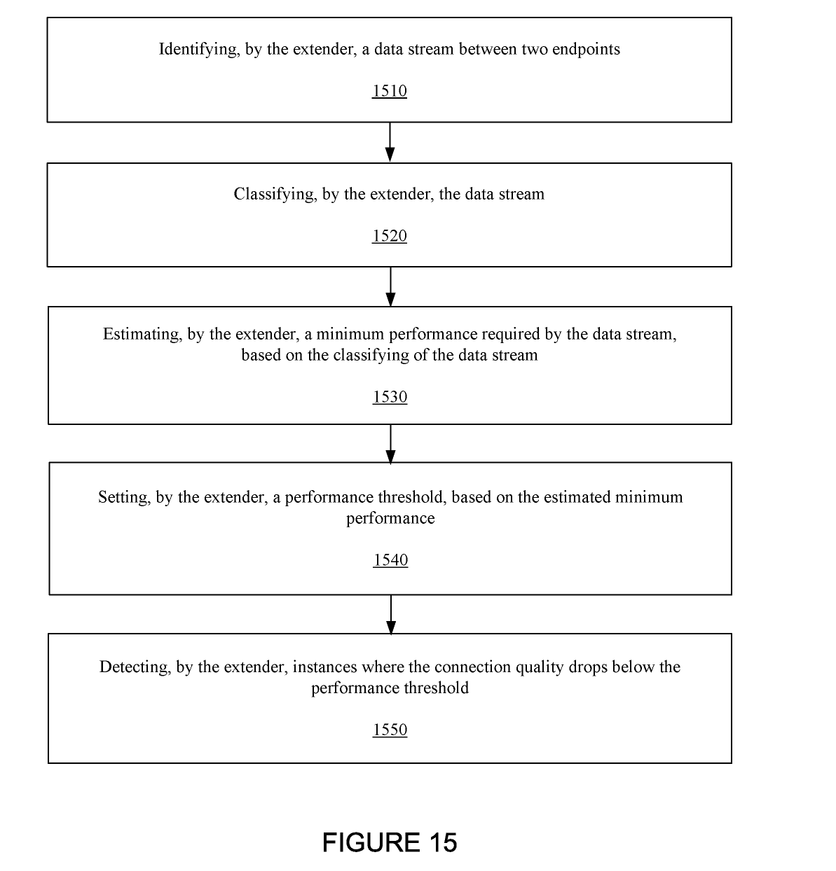

FIG. 15 is a flow chart that includes steps of a method of identifying and classifying a data stream, estimating a minimum performance required by the data stream, setting a performance threshold based on the minimum performance, and detecting instances where the connection quality falls below the performance threshold, according to an embodiment.

A first step 1510 includes identifying, by an extender, a data stream between two connection endpoints. In an embodiment, the data stream is identified through inspection of wireless data frames comprising the data stream. In an embodiment, the data stream is identified through a combination of a first and a second IP addresses and a first and second TCP or UDP port numbers. For example, a data stream may comprise a streaming TCP connection between a first IP address corresponding to a mobile device such as a smartphone and a second IP address corresponding to a server on the Internet.

A second step 1420 includes, classifying, by the extender the data stream. In an embodiment, the data stream is classified through inspection of the wireless data frames comprising the data stream. For example, wireless data frames from the data stream may contain Quality of Service bits within the frame header fields to indicate a class of traffic. In an embodiment, the data stream is classified through inspection of the IP packets comprising the data stream. For example, a data stream may be classified as web traffic based on it comprising TCP packets having a source or destination port of 80 or 443 within the packet headers. In an embodiment, the data stream is classified through inference based on traffic characteristics of an application. In an embodiment, a data stream between a source and destination pair may be categorized as voice traffic based on traffic characteristics including packet sizes (e.g., 100 byte packets) and inter-packet spacing (e.g., a packet every 20 ms). In an embodiment, the data stream may be classified according to application type or according to a specific application. For example, the data stream may be classified as comprising video traffic. For example, the data stream may be classified as the Facetime protocol for voice or video.

A third step 1430 includes estimating, by the extender, a minimum performance required by the data stream, based on the stream. For an embodiment, the extender estimates the performance required by a data stream by estimating a minimum throughput required by the application corresponding to that data stream. For example, the extender may estimate that a data stream classified as Skype voice protocol requires a minimum of 128 Kbps of bidirectional throughput. For example, the extender may estimate that a data stream classified as a Netflix video stream requires a minimum of 5 megabits per second of downlink throughput. For an embodiment, the extender estimates the performance required by a data stream by estimating a maximum end-to-end latency tolerable by the application corresponding to that data stream. For example, the extender may estimate that a data stream classified as a voice call requires an end-to-end wireless latency of less than 30 milliseconds. For an embodiment, the extender estimates the performance required by a data stream by estimating a maximum jitter tolerable by the application corresponding to that data stream. For an embodiment, the extender estimates the performance required by a data stream by estimating a maximum packet loss rate tolerable by the application corresponding to that data stream.

A fourth step 1440 includes setting, by the extender, a performance threshold based on the estimated minimum performance. For an embodiment, the performance threshold can be set to exceed the minimum performance requirement. For example, if the extender identifies a data stream and classifies it as a video stream requiring a minimum performance of 3 Mbps downstream throughput, it may set a performance threshold to 5 Mbps.

A fifth step 1450 includes detecting, by the extender, instances where the connection quality drops below the performance threshold. Once the connection quality has been determined by the extender to have failed a connection quality test, the previously described recommendation for changing a physical configuration of the network may be made.

Although specific embodiments have been described and illustrated, the embodiments are not to be limited to the specific forms or arrangements of parts so described and illustrated.

1. A wireless extender, comprising:
a wireless transceiver operative to support a wireless connection between the wireless extender and an access point of a network;
a controller operative to:
monitor a connection quality of the wireless connection between the wireless extender and the access point;
determine when the connection quality fails a connection quality test comprising detecting instances when the connection quality drops below a performance threshold, wherein the performance threshold is adaptively set based on a data stream being forwarded by the wireless extender for one or more applications of one or more devices; and
select one or more recommendations when the connection quality is determined to have failed the connection quality test, wherein the selected one or more recommendations includes changing a physical configuration of the network.

2. The wireless extender of claim 1, wherein the one or more devices comprises a plurality of devices, and the one or more applications comprises a plurality of applications that are operating on the plurality of devices, and wherein the performance threshold is adaptively set based on a plurality of application performance thresholds of the plurality of applications.

3. The wireless extender of claim 1, wherein the wireless extender is further operative to inspect wireless frames of IP packets of the data stream to identify the data stream between two communication endpoints.

4. The wireless extender of claim 1, wherein the wireless extender is further operative to classify the data stream based on inspection of wireless frames of the data stream, inspection of IP packets of the data steam, or inference based on traffic characteristics of the one or more applications.

5. The wireless extender of claim 4, wherein the wireless extender is further operative to estimate a minimum performance required by the data stream based on the classification of the data stream.

6. The wireless extender of claim 5, wherein the wireless extender is further operative to set the performance threshold based on the estimate of the minimum performance required by the data stream.

7. The wireless extender of claim 1, wherein the connection quality includes a link quality between the wireless extender and an upstream access point.

8. The wireless extender of claim 1, wherein the connection quality includes a path quality between the wireless extender and an upstream access point, wherein the upstream access point is multiple wireless hops upstream from the wireless extender.

9. The wireless extender of claim 1, wherein determining when the connection quality fails a connection quality test comprises detecting a plurality of events and determining when the connection quality fails a connection quality test based on the detected plurality of events.

10. The wireless extender of claim 9, wherein detecting the plurality of events includes detecting instances when the connection quality drops below a performance threshold, and the connection quality is determined to have failed the connection quality test if a number of detected instances within a specified duration exceeds an allowable maximum number.

11. The wireless extender of claim 9, wherein detecting the plurality of events includes detecting instantaneous measurements of the connection quality, and the connection quality test is deemed to have failed if an average of the instantaneous connection quality measurements over a specified duration falls below a minimum threshold value.

12. The wireless extender of claim 9, wherein detecting the plurality of events includes detecting a sequence of instantaneous measurements of the connection quality within a specified time interval, and the connection quality test is deemed to have failed if a number of connection quality measurements within that time interval that fall below a threshold value (t), exceed a threshold number.

13. A method, comprising:
monitoring a connection quality of a wireless connection between a wireless extender and an access point of a network;
determining when the connection quality fails a connection quality test comprising detecting instances when the connection quality drops below a performance threshold, wherein the performance threshold is adaptively set based on a data stream being forwarded by the wireless extender for one or more applications of one or more devices; and
selecting one or more recommendations when the connection quality is determined to have failed the connection quality test, wherein the selected one or more recommendations includes changing a physical configuration of the network.

14. The method of claim 13, further comprising inspecting wireless frames of IP packets of the data stream to identify the data stream between two communication endpoints.

15. The method of claim 13, further comprising classifying the data stream based on inspection of wireless frames of the data stream, inspection of IP packets of the data steam, or inference based on traffic characteristics of the one or more applications.

16. The method of claim 15, further comprising estimating a minimum performance required by the data stream based on the classification of the data stream.

17. The method of claim 13, wherein the connection quality includes a link quality between the wireless extender and an upstream access point.

18. The method of claim 13, wherein the connection quality includes a path quality between the wireless extender and an upstream access point, wherein the upstream access point is multiple wireless hops upstream from the wireless extender.

19. The method of claim 13, wherein determining when the connection quality fails a connection quality test comprises detect a plurality of events and determine when the connection quality fails a connection quality test based on the detected plurality of events.

20. The method of claim 13, wherein determining when the connection quality fails a connection quality test comprises detecting a plurality of events and determining when the connection quality fails a connection quality test based on the detected plurality of events.

21. The method of claim 13, wherein detecting the plurality of events includes detecting instantaneous measurements of the connection quality, and the connection quality test is deemed to have failed if an average of the instantaneous connection quality measurements over a specified duration falls below a minimum threshold value.

22. The method of claim 13, wherein detecting the plurality of events includes detecting a sequence of instantaneous measurements of the connection quality within a specified time interval, and the connection quality test is deemed to have failed if a number of connection quality measurements within that time interval that fall below a threshold value (t), exceed a threshold number.
